(19) United States
(12) Patent Application Publication
(10) Pub. No.: US 2012/0274689 A1
(43) Pub. Date: Nov. 1, 2012

(54) LIQUID EJECTING APPARATUS AND METHOD OF CONTROLLING LIQUID EJECTING APPARATUS

(75) Inventor: Junhua ZHANG, Shiojiri (JP)

(73) Assignee: SEIKO EPSON CORPORATION, Tokyo (JP)

(21) Appl. No.: 13/454,539

(22) Filed: Apr. 24, 2012

(30) Foreign Application Priority Data
Apr. 26, 2011 (JP) 2011-097813

(51) Int. Cl. B41J 29/38

(52) U.S. Cl. 347/10

(57) ABSTRACT

A liquid ejecting apparatus in which a more efficient micro-vibration of just the right degree is possible, by changing an applied frequency, or a micro-vibration voltage of a micro-vibration pulse with respect to a piezoelectric vibrator in a non-ejection period according to ejection data of one pass, or the length of the continuous non-ejection period which is determined from ejection data from a predetermined flushing processing to the subsequent flushing processing, and a continuous ejection period before and after the non-ejection period.

The entire disclosure of Japanese Patent Application No. 2011-097813, filed Apr. 26, 2011 is expressly incorporated by reference herein.

### BACKGROUND

1. Technical Field

The present invention relates to a liquid ejecting apparatus including a liquid ejecting head such as an ink jet type recording head, and a method of controlling the liquid ejecting apparatus, and particularly relates to a liquid ejecting apparatus which adopts a configuration in which the menisci of nozzles which do not eject liquid during the ejecting process are caused to be finely vibrated, and a method of control the liquid ejecting apparatus.

2. Related Art

The liquid ejecting apparatus is an apparatus which includes a liquid ejecting head, and ejects various liquid from the liquid ejecting head. As the liquid ejecting apparatus, for example, there is an image recording device such as an ink jet type printer, or an ink jet type plotter; however, in recent years, the liquid ejecting apparatus has also been applied to a variety of manufacturing devices by taking advantage of properties in which it is possible to make very small amounts of liquid land on a predetermined position accurately. For example, the liquid ejecting apparatus has been applied to a display manufacturing device which manufactures a color filter such as a liquid crystal display, an organic EL (Electro Luminescent) display, an electrode forming apparatus which forms electrodes such as an FED (Field Emission Display), or a chip manufacturing device which manufactures biochip (a biochemical element). In addition, the recording head for the image recording device ejects liquid type ink, and a color material ejecting head for a display manufacturing device ejects a solution of each color material of R (Red), G (Green), and B (Blue). In addition, an electrode material ejecting head for the electrode forming apparatus ejects a liquid type electrode material, and a biological organic matter ejecting head for the chip manufacturing device ejects solution of a biological organic material.

Since the liquid (meniscus) in the nozzle is exposed to air in such types of liquid ejecting heads, there is a case where the liquid is thickened due to evaporation of a solvent component included in the liquid, or the like. When the liquid thickens, there is a concern that the liquid may not be properly ejected from the nozzle. In order to suppress such thickening of the liquid, the liquid and meniscus in a pressure chamber are finely vibrated to an extent such that it will not eject liquid from the nozzle by applying a micro-vibration pulse to a corresponding pressure generation unit (for example, a piezoelectric vibrator, a heating element, or the like) with respect to nozzles which do not eject liquid during the liquid ejecting operation (for example, during performing printing in the printer). That is, due to the micro vibration, the liquid in the vicinity of the nozzle is agitated, and the thickening of liquid is suppressed (for example, refer to JPA-2000-037867). The invention disclosed in JP-A-2000-037867 selects an application pattern of the micro vibration according to the operation state of the nozzle.

Meanwhile, in recent years, in the above described printer, there is a case where photo-curable ink which is cured by irradiation of a luminous energy such as UV light is used when printing an image or the like. Since the photo-curable ink is cured and fixed by being irradiated with light even for a recording medium with poor ink absorbency, accordingly, it has various uses, for example, image recording on a resin film, or other uses. However, the photo-curable ink tends to have high viscosity compared to general water-based ink. For example, the viscosity of the photo-curable ink at room temperature is 8 mPa·s or more, with respect to the viscosity of the water-based ink at the room temperature (for example, 20° C.) is less than 8 mPa·s. In addition to this, the liquid crystal or the like is also a type of liquid with high viscosity. In such a configuration treating such so-called high viscosity liquids, the control of viscosity becomes more important. For this reason, it is desirable for the apparatus for ejecting liquids, which include such a high viscosity liquid, to perform an efficient micro-vibration operation of just the right degree.

### SUMMARY

An advantage of some aspects of the invention is to provide a liquid ejecting apparatus able to perform an efficient micro-vibration operation of just the right degree, and a method of controlling the liquid ejecting apparatus.

According to an aspect of the invention, there is provided a liquid ejecting apparatus which includes, a liquid ejecting head which generates a pressure fluctuation in a pressure chamber by driving a pressure generation unit, by applying a driving signal, and ejects liquid from nozzles using the pressure fluctuation; a driving signal generation unit which generates a driving signal including a micro-vibration pulse generating the pressure fluctuation in liquid in the pressure chamber to an extent such that it will not eject liquid from the nozzles in repeated cycles; and a control unit which controls ejecting of the liquid by the liquid ejecting head on the basis of ejection data denoting the ejecting, or non-ejecting of the liquid in each repeated cycle, and controls the micro-vibration operations for each nozzle using the micro-vibration pulse, in which the control unit changes an applied frequency of the micro-vibration pulse, or a driving voltage of the micro-vibration pulse with respect to the pressure generation unit in a continuous non-ejecting period, according to the length of the non-ejecting period which is determined from the ejection data.

According to the invention, it becomes possible to perform an efficient micro-vibration of just the right degree by changing the applied frequency of the micro-vibration pulse, or the driving voltage of the micro-vibration pulse with respect to the pressure generation unit in the non-ejecting period, according to the length of the continuous non-ejecting period which is determined from the ejection data. That is, it is possible to prevent the viscosity from increasing by performing more frequent and greater micro-vibration in conditions in which the liquid is prone to thicken. In conditions in which the liquid is less likely to thicken, by performing less frequent and smaller micro-vibration, it is possible to lower power consumption, to suppress heating of the apparatus, and to enable long life of the apparatus. In addition, since it is possible to perform more efficient micro-vibration, particularly, it is preferable for a configuration in which liquid with high viscosity is ejected.

In the liquid ejecting apparatus, the control unit may have a configuration in which the applied frequency of the micro-vibration pulse, or the driving voltage of the micro-vibration pulse with respect to the pressure generation unit in a non-ejecting period can be changed according to the continuous ejecting period before and after the non-ejecting period.

According to the above configuration, it is possible to perform more efficient micro-vibration which is neither too much nor too little, by changing the applied frequency of the micro-vibration pulse, or the driving voltage of the micro-vibration pulse with respect to the pressure generation unit in the non-ejecting period, according to the continuous ejecting period before and after the non-ejecting period.

In the liquid ejecting apparatus, the control unit may have a configuration in which the applied frequency of the micro-vibration pulse, or the driving voltage of the micro-vibration pulse with respect to the pressure generation unit in the non-ejecting period can be changed according to the proportion of the entire unit period of controlling from a cycle of a target in which the micro-vibration pulse is set, to the last unit cycle of the unit period of controlling.

In addition, the “unit period of control” means a pass as a unit of scanning of the liquid ejecting head, or a predetermined flushing processing (ejecting of liquid which is performed in order to discharge thickened liquid or bubbles in the liquid ejecting head separately from ejecting liquid onto an ejection target), or a period from a starting point of the ejecting process to the next flushing processing.

According to the configuration, it may be possible to perform the more efficient micro-vibration of just the right degree by changing the applied frequency of the micro-vibration pulse, or the driving voltage of the micro-vibration pulse with respect to the pressure generation unit in the non-ejecting period according to the ratio with respect to the entire unit period of controlling from a cycle of a target in which the micro-vibration pulse is set (current cycle) to the last unit cycle of the unit period of controlling (remaining period).

In the liquid ejecting apparatus, the driving signal may have a configuration in which a plurality of micro-vibration pulses is included in one repeated cycle.

According to the configuration, it is possible to easily change the applied frequency of the micro-vibration pulse by having a configuration in which the plurality of micro-vibration pulses is included in the driving signal.

In the liquid ejecting apparatus, the driving signal may have a configuration in which the plurality of micro-vibration pulses with different driving voltages from each other is included in one repeated cycle.

According to the configuration, it is possible to easily change the driving voltage of the micro-vibration pulse by having a configuration in which the plurality of micro-vibration pulses with different driving voltages from each other is included in the driving signal.

According to another aspect of the invention, there is provided a method of controlling a liquid ejecting apparatus which includes, a liquid ejecting head which generates a pressure fluctuation in a pressure chamber by driving a pressure generation unit, by applying a driving signal, and ejects liquid from nozzles using pressure fluctuation; a driving signal generation unit which generates a driving signal including a micro-vibration pulse generating the pressure fluctuation in liquid in the pressure chamber to an extent such that it will not eject liquid from the nozzles in repeated cycles; and a control unit which controls ejecting of liquid by the liquid ejecting head on the basis of ejection data denoting the ejecting, or non-ejecting of the liquid in each repeated cycle, and controls the micro-vibration operations for each nozzle using the micro-vibration pulse, and the method includes changing the applied frequency of a micro-vibration pulse, or a driving voltage of a micro-vibration pulse with respect to the pressure generation unit in a non-ejecting period, according to the length of the continuous non-ejecting period which is determined from ejection data.

### BRIEF DESCRIPTION OF THE DRAWINGS

The invention will be described with reference to the accompanying drawings, wherein like numbers reference like elements.

FIG. 1 is a perspective view which illustrates a configuration of a printer.

FIG. 2 is a cross-sectional view of a recording head.

FIG. 3 is a block diagram which illustrates an electrical configuration of the printer.

FIG. 4 is a wave form chart which illustrates a configuration of a driving signal.

FIG. 5 is a wave form chart which illustrates a configuration of a driving pulse which is included in the driving signal.

FIG. 6 is a timing chart relating to an ejection of ink.

FIG. 7 is a table which corresponds to a determination of pulse selection data of a micro-vibration pulse.

FIG. 8 is a table which corresponds to a determination of pulse selection data according to another embodiment.

### DESCRIPTION OF EXEMPLARY EMBODIMENTS

Hereinafter, embodiments of the invention will be described with reference to accompanying drawings. In addition, in the embodiments to be described later, a variety of limitations are made as preferable examples of the invention, however, the scope of the invention is not limited to these embodiments as long as there is no particular description of limiting the invention in the following descriptions. In addition, in the following descriptions, an ink jet type printer will be exemplified (a type of a liquid ejecting apparatus of the invention) as the liquid ejecting apparatus of the invention.

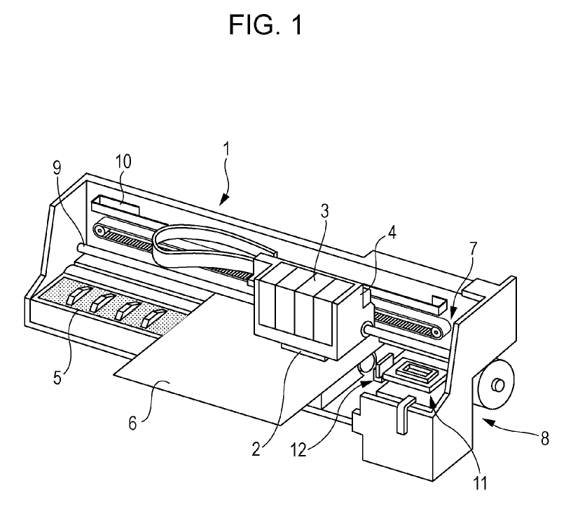

FIG. 1 is a perspective view which shows a configuration of a printer 1. The printer 1 includes a carriage 4 which is attached with a recording head 2 as a liquid ejecting head, and is detachably attached with an ink cartridge 3, a platen 5 which is provided at the lower part of the recording head 2, a carriage moving mechanism 7 which causes the recording head 2 mounted to the carriage 4 to reciprocate in the paper width direction of a recording sheet 6 (a type of ejection target), that is, in the main scanning direction, and a paper feeding mechanism 8 which transports the recording sheet 6 in the sub-scanning direction which is orthogonal to the main scanning direction.

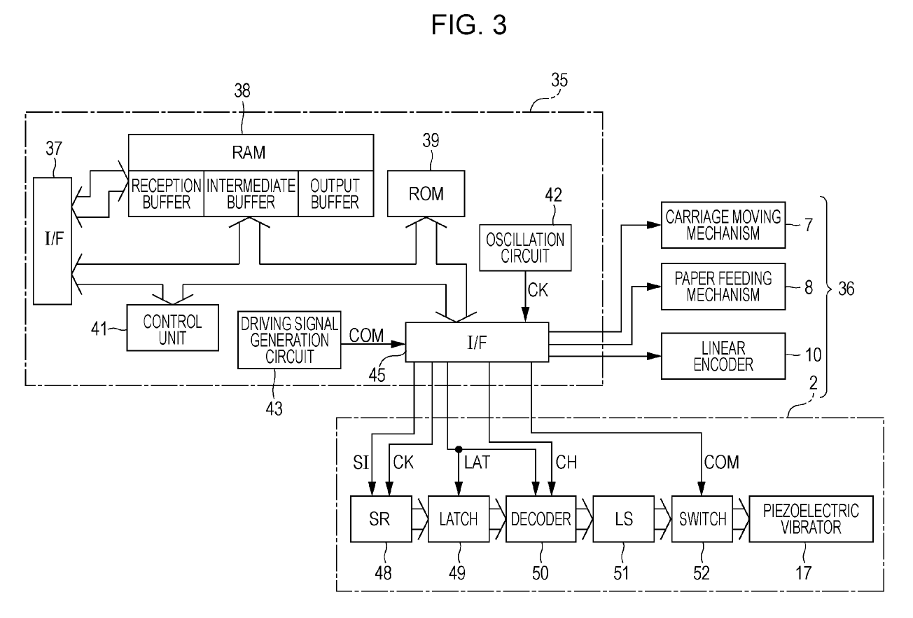

The carriage 4 is attached to a guide rod 9 which is installed in the main scanning direction in a state of being pivotally supported, and moves in the main scanning direction along the guide rod 9 by an operation of the carriage moving mechanism 7. The position of the carriage 4 in the main scanning direction is detected by a linear encoder 10, and a detection signal thereof, that is, an encoder pulse is transmitted to a control unit 41 of a printer controller (refer to FIG. 3). In this manner, the control unit 41 is able to control a recording operation (ejecting operation) or the like, by the recording head 2 while recognizing the scanning position of the carriage 4 (recording head 2) on the basis of the encoder pulse from the linear encoder 10. In addition, the printer 1 performs recording of characters, images, or the like on the recording sheet 6 in both directions of an outward movement in which the carriage 4 (recording head 2) moves toward an end portion which is opposite the home position and a return movement in which the carriage 4 returns to the home position side from the end portion on the opposite side.

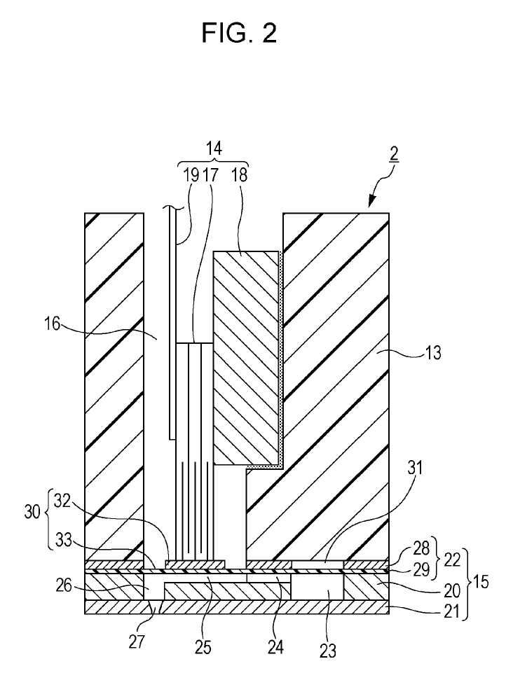

The home position as a base point of the scanning is set at the outer side of a recording region in a moving range of the carriage 4. The home position according to the embodiment is arranged with a capping member 11 which seals a nozzle forming surface (nozzle plate 21: refer to FIG. 2) of the recording head 2, and a wiper member 12 for wiping out the nozzle forming surface are arranged. The above described capping member 11 is a member which is formed in a tray shape of which the top face is open by an elastic member such as elastomer, or rubber. The capping (sealing) is performed by pushing the open surface of the capping member 11 against the nozzle forming surface of the recording head 2. In the capping state, it is possible to suppress evaporation of solvent of the ink from nozzles 27 of the recording head 2. In addition, the capping member 11 also functions as an ink reception unit which receives ink droplets in the flushing processing. In the flushing processing, the recording head 2 is moved to the capping member 11 which is located at a position separated from the recording medium, or the ink reception unit which is referred to as a flushing point other than that for each periodic pass, or for each of a predetermined number of passes (scanning units of recording head 2), and the thickened ink, or bubbles are discharged to the reception unit by ejecting the ink droplets at the position. In this manner, an ink ejection ability of the apparatus can be prevented from deteriorating.

FIG. 2 is a cross-sectional view of a main portion which describes a configuration of the recording head 2. The recording head 2 is configured by a case 13, a vibrator unit 14 which is accommodated in the case 13, a flow path unit 15 which is bonded to bottom face (tip end surface) of the case 13, or the like. The case 13 is, for example, produced using epoxy resin, and is formed with an empty storage unit 16 for storing the vibrator unit 14 therein. The vibrator unit 14 includes a piezoelectric vibrator 17 which functions as a type of the pressure generation unit, a fixing plate 18 which is bonded with the piezoelectric vibrator 17, and a flexible cable 19 for supplying the driving signal or the like to the piezoelectric vibrator 17. The piezoelectric vibrator 17 is a lamination-type vibrator in which a piezoelectric plate made by alternately laminating a piezoelectric layer and an electrode layer is carved in a comb shape, and which has a so-called longitudinal vibration mode which is able to expand or contract in a direction orthogonal to the laminating direction.

The flow path unit 15 is configured by respectively bonding the nozzle plate 21 onto one surface of a passage forming substrate 20, and an elastic plate 22 onto the other surface of the passage forming substrate 20. The flow path unit 15 is provided with a reservoir 23 (a common liquid chamber), an ink supply port 24, the pressure chamber 25, a nozzle communication port 26, and the nozzles 27. In addition, a series of ink flow path from the ink supply port 24 to the nozzles 27 through the pressure chamber 25 and the nozzle communication port 26 is formed corresponding to each nozzle 27.

The above described nozzle plate 21 is a thin plate which is made of metal such as stainless on which the plurality of nozzles 27 is drilled in a column shape at a pitch corresponding to the dot formation density (for example 180 dpi). The nozzle plate 21 is provided with a plurality of columns of the nozzles 27 (nozzle column), and one nozzle column is configured by, for example, nozzles 27 of 180. In addition, the recording head 2 according to the embodiment is configured to be able to mount four ink cartridges 3 which store ink of different colors from each other (a type of liquid in the invention), specifically, four colors of ink, cyan (C), magenta (M), yellow (Y), and black (K) in total, and nozzle columns of four columns in total are formed on the nozzle plate 21 corresponding to these colors.

The above described elastic plate 22 has a double structure in which an elastic film 29 is laminated on the front surface of the support plate 28. According to the embodiment, the elastic plate 22 is produced such that a stainless plate as a type of a metal plate is set as the support plate 28, and a composite plate on which a resin film is laminated as the elastic film 29 on the front surface of the support plate 28 is used. The elastic plate 22 is provided with a diaphragm unit 30 which changes the volume of the pressure chamber 25. In addition, the elastic plate 22 is provided with a compliance unit 31 which seals a part of the reservoir 23.

The above described diaphragm unit 30 is produced by partially eliminating the support plate 28 using etching processing or the like. That is, the diaphragm unit 30 is configured by an island portion 32 to which the tip end surface of the piezoelectric vibrator 17 is bonded, and a thin elastic portion 33 which surrounds the island portion 32. The above described compliance unit 31 is produced by eliminating the support plate 28 in a region which faces the aperture of the reservoir 23 using etching processing or the like, similarly to the diaphragm unit 30, and functions as a damper which absorbs the pressure fluctuation of the liquid which is stored in the reservoir 23.

In addition, since the tip end surface of the piezoelectric vibrator 17 is bonded to the above described island portion 32, it is possible to cause the volume of the pressure chamber 25 to vary by expanding or contracting the piezoelectric vibrator 17. The pressure fluctuation of the ink in the pressure chamber 25 is caused accompanying the volume variation. In addition, the recording head 2 causes ink droplets to be ejected from the nozzle 27 using the pressure fluctuation.

FIG. 3 is a block diagram which shows an electrical configuration of the printer 1. The printer 1 is configured by a printer controller 35 and a printer engine 36. The printer controller 35 includes an external interface (external I/F) 37 to which printing data or the like is input from external devices such as a host computer or the like, a RAM 38 which stores various data or the like, a ROM 39 which stores control routine or the like for processing of various data, a control unit 41 which controls each unit, an oscillation circuit 42 which generates a clock signal, a driving signal generation circuit 43 which generates a driving signal to be supplied to the recording head 2 (a type of a driving signal generation unit according to the invention), and an internal interface (internal I/F) 45 for outputting ejection data which is obtained by deploying printing data in each dot (dot pattern data, or pixel data), the driving signal, or the like to the recording head 2.

The control unit 41 outputs a head control signal for controlling an operation of the recording head 2 to the recording head 2, or outputs a control signal for generating the driving signal COM to the driving signal generation circuit 43. The head control signals are, for example, the transmission clock CLK, the ejection data SI, the latch signal LAT, the first change signal CH1, and the second change signal CH2. These latch signals, or the change signals define supply timing of each pulse which configures the driving signals COM 1, and COM 2.

In addition, the control unit 41 generates the ejection data SI which is used in the ejection control of the recording head 2 by being subject to color conversion processing from the RGB colorimetric system to the CMY colorimetric system, half-toning in which data of multi-grayscale is reduced to predetermined grayscale, dot pattern deploying processing in which half-toned data is deployed in the dot pattern data by being aligned in a predetermined arrangement in each type of ink (in each nozzle), or the like, on the basis of the printing data. The ejection data SI is data relating to pixels of an image to be printed, and a type of ejection control information. Here, pixels denote a dot forming region which is virtually determined on a recording medium such as a recording sheet as an ejection target. In addition, the ejection data SI according to the invention is configured by grayscale data relating to the presence or absence of dots formed on the recording medium (or the presence or absence of ejection of ink), and the size of dots (or the ejecting amount of ink). According to the embodiment, the ejection data SI is configured by binary grayscale data of two bits in total. In the grayscale value of two bits, there are: [00] which corresponds to non-recording (micro-vibration to be described later) in which ink is not ejected, [01] which corresponds to recording of a small dot, [10] which corresponds to recording of a middle-sized dot, and [11] which corresponds to recording of a large dot. Accordingly, the printer in the embodiment is able to perform recording in four levels of grayscale. In addition, the control unit 41 and a decoder 48 according to the embodiment control the ejection of ink by the recording head 2 on the basis of the ejection data SI, and functions as a control unit which controls an operation of the micro-vibration using a micro-vibration pulse to be described later for each nozzle.

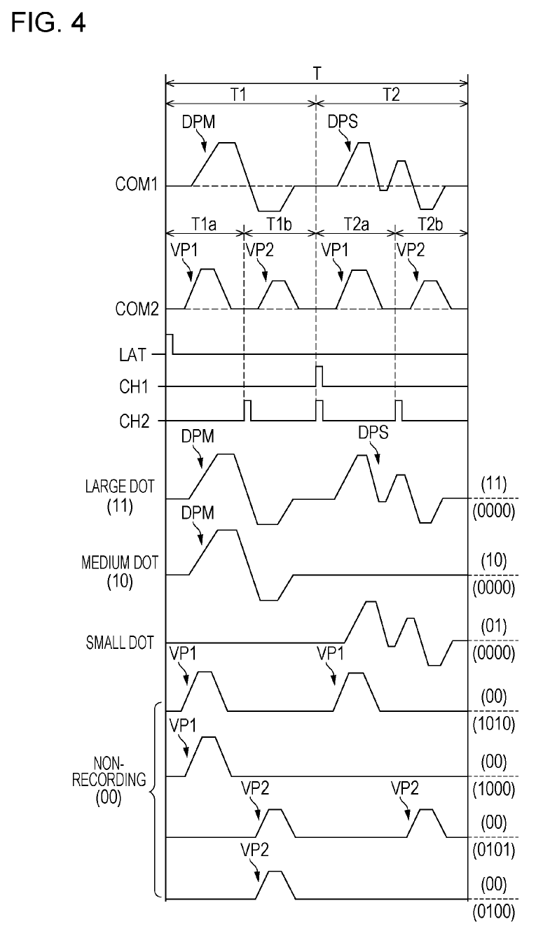

The driving signal generation circuit 43 is controlled by the control unit 41, and generates a variety of driving signals. FIG. 4 is a diagram which describes an example of a configuration of the driving signal COM which is generated by the driving signal generation circuit 43. The first driving signal COM1 is a series of signal which has the middle-sized dot ejection pulse DPM and the small dot ejection pulse DPS in one repeating cycle T (an interval based on the encoder pulse, and a period corresponding to one pixel, and hereinafter, referred to as a unit cycle) in the embodiment. According to the embodiment, the one unit cycle T of the first driving signal COM1 is classified into two pulse generation periods of T1 and T2. In addition, the middle-sized dot ejection pulse DPM is generated in the period T1, and the small dot ejection pulse DPS is generated in the period T2. On the other hand, the second driving signal COM2 is a series of signal which has a plurality of micro-vibration pulses VP in the unit cycle T. The period T1 in one unit cycle T of the second driving signal COM2 is divided into the first half T1a and the second half T1b, and the period T2 is divided into the first half T2a and the second half T2b. In the period T1a, the first micro-vibration pulse VP1 is generated, and in the period T1b, the second micro-vibration pulse VP2 is generated. In addition, in the period T2a, the first micro-vibration pulse VP1 is generated, and in the period T2b, the second micro-vibration pulse VP2 is generated. That is, in the second driving signal COM2 according to the embodiment, four micro-vibration pulses VP in total are included in the unit period T. In addition, relating to the size of the ink, (or the size of dots which are formed on the recording medium), middle, small, or the like are attached names on the specifications of the printer, and are not limited to the examples regarding the correspondence of the names to the ejected amount of ink.

Subsequently, a configuration on the printer engine 36 side will be described. The printer engine 36 is configured by the recording head 2, the carriage moving mechanism 7, the paper feeding mechanism 8, and the linear encoder 10. The recording head 2 includes a plurality of a shift register (SR) 48, a latch 49, a decoder 50, a level shifter (LS) 51, a switch 52, and the piezoelectric vibrator 17 which is caused to correspond to each nozzle opening 27. The ejection data (SI) from the printer controller 35 is serially transmitted to the shift register 48 by being synchronized with the clock signal (CK) from the oscillation circuit 42.

The shift register 48 is electrically connected with the latch 49, and when a latch signal (LAT) is input to the latch 49 from the printer controller 35, the ejection data of the shift register 48 is latched by the latch. The ejection data latched by the latch 49 is input to the decoder 50. The decoder 50 generates pulse selection data by analyzing the ejection data of two bits. The pulse selection data in the embodiment is generated for each of driving signal COM1 and COM2. That is, the first pulse selection data corresponding to the first driving signal COM1 is configured by two bits of data in total which correspond to the middle-sized dot ejection pulse DPM (period T1), and the small dot ejection pulse DPS (period T2). In addition, the second pulse selection data corresponding to the second driving signal COM2 is configured by four bits of data in total corresponding to the first micro-vibration pulse VP1 (period T1a), the second micro-vibration pulse VP2 (period T1b), the first micro-vibration pulse VP1 (period T2a), the second micro-vibration pulse VP2 (period T2b).

In addition, the decoder 50 outputs the pulse selection data to a level shifter 51 by having an opportunity of receiving the latch signal (LAT), or a channel signal (CH). In this case, the pulse selection data is input to the level shifter 51 in order from the high-order bit. The level shifter 51 functions as a voltage amplifier, and when the pulse selection data is [1], the level shifter outputs a voltage which can drive the switch 52, for example, an electrical signal which is boosted to voltages of about several tens of volts. The pulse selection data [1] which is boosted in the level shifter 51 is supplied to the switch 52. The driving signals COM1 and COM2 from the driving signal generation circuit 43 are supplied to the input side of the switch 52, and the piezoelectric vibrator 17 is connected to the output side of the switch 52.

In addition, the pulse selection data controls the operation of the switch 52, that is, an application of the ejection pulse in the driving signal to the piezoelectric vibrator 17. For example, the switch 52 is in a connected state, a corresponding ejection pulse is applied to the piezoelectric vibrator 17, and a potential level of the piezoelectric vibrator 17 is changed by being modeled after the waveform of the ejection pulse during in which the pulse selection data input to the switch 52 is [1]. On the other hand, the electrical signal for operating the switch 52 is not output from the level shifter 51 during in which the pulse selection data is [0]. For this reason, the switch 52 is disconnected, and the ejection pulse is not applied to the piezoelectric vibrator 17.

That is, it is possible to selectively apply a part of the first driving signal COM1, or the second driving signal COM2 to the piezoelectric vibrator 17 at a start timing of the repeating period T (unit period) (a timing of latch pulse of latch signal LAT). In this example, it is possible to switch the driving signal COM which is applied to the piezoelectric vibrator 17 from the first driving signal COM1 to the second driving signal COM2, or vise versa. Similarly, it is possible to switch the pulse to be applied to the piezoelectric vibrator 17 at a timing of the boundary between the T1 and T2 in the first driving signal COM1, or a timing of the boundary among the T1a, T1b, T2a, and T2b in the second driving signal COM2 (timing of changing pulse of the first change signal CH1, and timing of changing pulse of the second change signal CH2).

Here, each pulse which is included in each of driving signal COM1 and COM2 which are generated by the driving signal generation circuit 43 will be described.

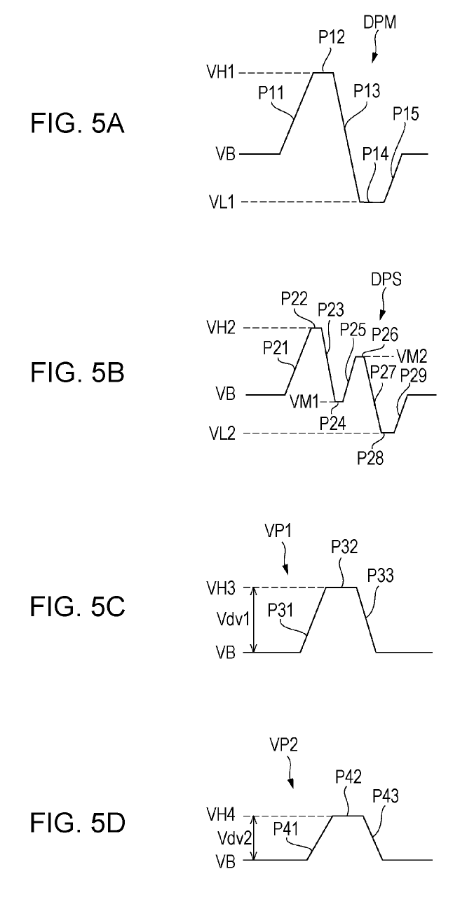

First, the middle-sized dot ejection pulse DPM which is generated in the period T1 in the first driving signal COM1 will be described. As shown in FIG. 5A, the middle-sized dot ejection pulse DPM is configured by a first change element P11 (pressure chamber expansion element), the first hold element P12 (expansion hold element), the second change element P13 (pressure chamber contraction element), the second hold element P14 (contraction hold element), and the third change element P15. The first change element P11 is a waveform element in which a potential is changed to the positive side (the first polar side) with a constant gradient to an extent such that it will not eject ink from the reference potential VB to the first expansion potential VH1. The first hold element P12 which is subsequent to the first change element P11 is a constant waveform element in the first expansion potential VH1 as a termination potential of the first change element P11. In addition, the second change element P13 which is subsequent to the first hold element P12 is a waveform element which steeply changes the potential to the negative side (the second polar side which is opposite to the first polar) from the first expansion potential VH1 to the first contraction potential VL1 (VL1<VB). The second hold element P14 is a constant waveform element in the first contraction potential VL1 as a termination potential of the second change element P13. The third change element P15 which is subsequent to the second hold element P14 is a waveform element which causes the potential to rise and return from the first contraction potential VL1 as the termination potential of the second hold element P14 to the reference potential VB.

When the middle-sized dot ejection pulse DPM which is configured in this manner is applied to the piezoelectric vibrator 17, first, the piezoelectric vibrator 17 is contracted in the longitudinal direction of the element by the first change element P11, and the pressure chamber 25 is expanded to an expansion volume corresponding to the first expansion potential VH1 from the reference volume corresponding to the reference potential VB. Due to the expansion, the surface (meniscus) of ink which is exposed to the outside in the nozzle 27 is largely drawn to the pressure chamber 25 side, and the ink is supplied into the pressure chamber 25 from the reservoir 23 side through the ink supply port 24. In addition, the expansion state of the pressure chamber 25 is maintained during an applying period of the first hold elements P12. Thereafter, the piezoelectric vibrator 17 is expanded by being applied with the second change element P13. Due to the expansion of the piezoelectric vibrator 17, the pressure chamber 25 is steeply contracted from the expansion volume to the contraction volume corresponding to the first contraction potential VL1. Due to the steep contraction of the pressure chamber 25, ink in the pressure chamber 25 is pressurized, and ink of an amount corresponding to the middle-sized dot (for example, a dozen or so p1) is ejected from the nozzle 27. In addition, the contraction state of the pressure chamber 25 is maintained during the applying period of the second hold element P14, and thereafter, the third change element P15 is applied to the piezoelectric vibrator 17, and the contraction volume of the pressure chamber 25 returns to the reference volume.

In addition, as shown in FIG. 5B, the small dot ejection pulse DPS which is generated in the period T2 in the first driving signal COM1 is configured by the fourth change element P21, the third hold element P22, the fifth change element P23, the fourth hold element P24, the sixth change element P25, the fifth hold element P26, the seventh change element P27, the sixth hold element P28, and the eighth change element P29. The fourth change element P21 is a waveform element which changes the potential to the positive side with a constant gradient to an extent such that it will not eject ink from the reference potential VB to the second expansion potential VH2. The third hold element P22 which is subsequent to the fourth change element P21 is a constant waveform element in the second expansion potential VH2 as the termination potential of the fourth change element P21. In addition, the fifth change element P23 which is subsequent to the third hold element P22 is a waveform element which changes the potential to the negative side from the second expansion potential VH2 to the first intermediate potential VM1. The fourth hold element P24 which is subsequent to the fifth change element P23 is a constant waveform element in the first intermediate potential VM1. The sixth change element P25 which is subsequent to the fourth hold element P24 is a waveform element which changes the potential to the positive side from second intermediate potential VM2 (VH2>VM2>VM1>VL2). The fifth hold element P26 which is subsequent to the sixth change element P25 is a constant waveform element in the second intermediate potential VM2. The seventh change element P27 which is subsequent to the fifth hold element P26 is a waveform element which steeply changes the potential to the negative side from the second intermediate potential VM2 to the second contraction potential VL2. The sixth hold element P28 is a constant waveform element in the second contraction potential VL2. The eighth change element P29 which is subsequent to the sixth hold element P28 is a waveform element which causes the potential to rise and return to the reference potential VB from the second contraction potential VL2 as the termination potential of the sixth hold element P28.

When the small dot ejection pulse DPS which is configured in this manner is applied to the piezoelectric vibrator 17, first, the piezoelectric vibrator 17 contracts rapidly in the longitudinal direction of the element by the fourth change element 21, and the island portion 32 is displaced in a direction which is separated from the pressure chamber 25 accompanying the contraction of the piezoelectric vibrator. Due to the displacement of the island portion 32, the pressure chamber 25 is rapidly expanded to the expansion volume corresponding to the second expansion potential VH2 from the reference volume. Due to the expansion of the pressure chamber 25, a relatively strong negative pressure is generated in the pressure chamber 25, the meniscus is drawn to the pressure chamber 25 side, and the ink is supplied to the pressure chamber 25 from the reservoir 23 side. In addition, the expansion state of the pressure chamber 25 is maintained during the applying period of the third hold element P22.

Thereafter, the piezoelectric vibrator 17 is expanded by being applied with the fifth change element P23. Due to the expansion of the piezoelectric vibrator 17, the island portion 32 is rapidly displaced in a direction in which the island portion approaches the pressure chamber 25. Due to the displacement of the island portion 32, the pressure chamber 25 rapidly contracts to the contraction volume corresponding to the first intermediate potential VM1 from the expansion volume. In addition, due to the rapid contraction of the pressure chamber 25, the ink in the pressure chamber 25 is pressurized, and the center portion of the meniscus is pushed out to the ejection side. Subsequently, the fourth hold element P24 is applied, and the contraction volume is maintained for a short time. Subsequently, the volume of the pressure chamber 25 is expanded again due to the contraction of the piezoelectric vibrator 17 by the sixth change element P25, the piezoelectric vibrator 17 is expanded again by the seventh change element P27 through the fifth hold element P26, and then the volume of the pressure chamber 25 rapidly contracts again. The center portion of the meniscus is torn during the applying period of the element from the fourth hold element P24 to the seventh change element P27, and the portion is ejected as ink of an amount corresponding to the small dot (for example, a couple of p1). In addition, the contraction state of the pressure chamber 25 is maintained during the applying period of the sixth hold element P28, and thereafter, the eighth change element P29 is applied to the piezoelectric vibrator 17, and the pressure chamber 25 returns to the reference volume from the contraction volume.

FIG. 5C shows a waveform of the first micro-vibration pulse VP1 which is generated in the periods T1a and T2a in the second driving signal COM2. The first micro-vibration pulse VP1 is configured by the first micro-vibration change element P31, the first micro-vibration hold element P32, and the second micro-vibration change element P33. The first micro-vibration change element P31 is a waveform element which changes the potential to the positive side (rising) with a constant gradient which is relatively mild to an extent such that it will not eject ink from the reference potential VB to the first micro-vibration expansion potential VH3. The first micro-vibration hold element P32 which is subsequent to the first micro-vibration change element P31 is a constant waveform element in the first micro-vibration expansion potential VH3 as the termination potential of the first micro-vibration change element P31. The second micro-vibration change element P33 which is subsequent to the first micro-vibration hold element P32 is a waveform element which changes the potential to the negative side (falling) with the constant gradient from the first micro-vibration expansion potential VH3 to the reference potential VB.

When the first micro-vibration pulse VP1 configured in this manner is applied to the piezoelectric vibrator 17, first, the piezoelectric vibrator 17 is contracted in the longitudinal direction of the element by the first micro-vibration change element P31, and the pressure chamber 25 is expanded to the micro-vibration expansion volume corresponding to the first micro-vibration expansion potential VH3 from the reference volume corresponding to the reference potential VB. Due to the expansion, the meniscus is drawn to the pressure chamber 25 side. In addition, the expansion state of the pressure chamber 25 is maintained during the applying period of the first micro-vibration hold element P32. Thereafter, the piezoelectric vibrator 17 is expanded by being applied with the second micro-vibration change element P33. Due to the expansion of the piezoelectric vibrator 17, the pressure chamber 25 is contracted to the reference volume corresponding to the reference potential VB from the expansion volume. Here, the potential difference from the reference potential VB to the first micro-vibration expansion potential VH3, that is, the first micro-vibration voltage Vdv1 is set to a value which is sufficiently lower than the driving voltage of the small dot ejection pulse DPS, or the middle-sized dot ejection pulse DPM. For this reason, when the first micro-vibration pulse VP1 is applied to the piezoelectric vibrator 17, a pressure vibration of an extent such that it will not eject ink from the nozzle 27 is generated in the pressure chamber 25.

FIG. 5D shows a waveform of the second micro-vibration pulse VP2 which is generated in the periods T1b and T2b in the second driving signal COM2. The second micro-vibration pulse VP2 is configured by the third micro-vibration change element P41, the second micro-vibration hold element P42, and the fourth micro-vibration change element P43. The third micro-vibration change element P41 is a waveform element which changes the potential to the positive side (rising) with a gradient to an extent such that it will not eject ink from the reference potential VB to the second micro-vibration expansion potential VH4 (VH4<VH3). The second micro-vibration hold element P42 which is subsequent to the third micro-vibration change element P41 is a constant waveform element in the second micro-vibration expansion potential VH4 as the termination potential of the third micro-vibration change element P41. The fourth micro-vibration change element P43 which is subsequent to the second micro-vibration hold element P42 is a waveform element which changes the potential to the negative side (falling) with a constant gradient from the second micro-vibration expansion potential VH4 to the reference potential VB.

When the second micro-vibration pulse VP2 configured in this manner is applied to the piezoelectric vibrator 17, first, the piezoelectric vibrator 17 is contracted in the longitudinal direction of the element by the third micro-vibration change element P41, and the pressure chamber 25 is expanded to the micro-vibration expansion volume corresponding to the second micro-vibration expansion potential VH4 from the reference volume corresponding to the reference potential VB. Due to the expansion, the meniscus is drawn to the pressure chamber 25 side. In addition, the expansion state of the pressure chamber 25 is maintained during the applying period of the second micro-vibration hold element P42. Thereafter, the piezoelectric vibrator 17 is expanded by being applied with the fourth micro-vibration change element P43. Due to the expansion of the piezoelectric vibrator 17, the pressure chamber 25 is contracted to the reference volume corresponding to the reference potential VB from the expansion volume. Here, the potential difference from the reference potential VB to the second micro-vibration expansion potential VH4, that is, the second micro-vibration voltage Vdv2 of the second micro-vibration pulse VP2 is set to a value which is lower than the first micro-vibration voltage Vdv1 of the first micro-vibration pulse VP1. For this reason, when the first micro-vibration pulse VP1 is applied to the piezoelectric vibrator 17, a pressure vibration which is smaller than that using the first micro-vibration pulse VP1 is generated in the pressure chamber 25.

Subsequently, a case where the ejection data SI input to the decoder 48 in the above configuration is [11] will be described. In this case, according to the embodiment, the pulse selection data corresponding to the first driving signal COM1 is set to [11], and the pulse selection data corresponding to the second driving signal COM2 is set to [0000]. In this manner, as shown in FIG. 4, the middle-sized dot ejection pulse DPM of the first driving signal COM1 is applied to the piezoelectric vibrator 17 in the period T1, and the small dot ejection pulse DPS of the first driving signal COM1 is applied to the piezoelectric vibrator 17 in the period T2, in this order. On the other hand, in this case, any of the micro-vibration pulses of the second driving signal COM2 is not applied to the piezoelectric vibrator 17. As a result, ink is continuously ejected twice from the nozzle 27 in the unit cycle T, accordingly, a large dot is formed when the ink lands with respect to a pixel region on the ejection target.

When the ejection data SI is [10], the pulse selection data corresponding to the first driving signal COM1 is set to [10] in the embodiment, and the pulse selection data corresponding to the second driving signal COM2 is set to [0000]. In this manner, as shown in FIG. 4, the middle-sized dot ejection pulse DPM of the first driving signal COM1 is applied in the period T1, and on the other hand, any of the pulses of the first driving signal COM1 and the second driving signal COM2 is not applied to the piezoelectric vibrator 17 in the period T2. As a result, an amount of ink corresponding to the middle-sized dot is ejected once from the nozzle 27 in the unit cycle T, the ink lands with respect to a pixel region on the ejection target, and then the middle-sized dot is formed.

When the ejection data SI is [01], the pulse selection data corresponding to the first driving signal COM1 is set to [01] in the embodiment, and the pulse selection data corresponding to the second driving signal COM2 is set to [0000]. In this manner, as shown in FIG. 4, any of the pulses of the first driving signal COM1 and the second driving signal COM2 is not applied to the piezoelectric vibrator 17 in the period T1. In contrast to this, in the period T2, the small dot ejection pulse DPS of the second driving signal COM2 is applied to the piezoelectric vibrator 17. As a result, an amount of ink corresponding to the small dot is ejected once from the nozzle 27 in the unit cycle T, the ink lands with respect to a pixel region on the ejection target, and then the small dot is formed.

Here, in a case of non-recording in which ink is not ejected from the nozzle 27, that is, when the ejection data SI is [00], the pulse selection data corresponding to the first driving signal COM1 is set to [00]. On the other hand, one pulse selection data corresponding to the second driving signal COM2 is selected among the plurality of types of data items. According to the embodiment, four types in total of the pulse selection data items [1010], [1000], [0101], and [0100] corresponding to the second driving signal COM2 at the time of non-recording are prepared. In addition, the printer 1 according to the embodiment has properties, for example, of changing an applied frequency of the micro-vibration pulse VP with respect to the piezoelectric vibrator 17 in the non-ejection period, or a micro-vibration voltage of the micro-vibration pulse VP according to the ejection data SI of one pass (raster data), or a continuous non-ejection period (a period in which a unit cycle in which ink is not ejected even once is set to a non-ejection cycle, and the non-ejection cycle is continued. That is, a total of the non-ejection cycle between the last ink ejection and the next ink ejection thereafter) which is determined from the ejection data SI between a predetermined flushing processing and the subsequent flushing processing, and a continuous ejection period before and after the non-ejection period (a period in which ink is ejected at least once is set to the ejection cycle, and the ejection cycle is continued). Hereinafter, the properties will be described.

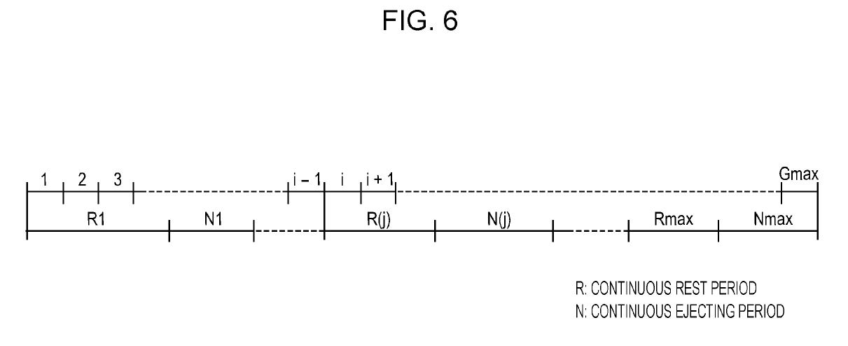

FIG. 6 shows a timing chart relating to the ejection of ink in one pass, or a period from a predetermined flushing processing to the next flushing processing (hereinafter, referred to as a unit period of control). The upper stage of the timing chart denotes a unit cycle, and the lower stage denotes an example of a generation pattern of the continuous non-ejection period (continuous rest period) R, and the continuous ejection period N. In the figure, i is a unit cycle of a target to which a control unit (the control unit 41, and the decoder 48) is to set the micro-vibration pulse (hereinafter, referred to as a target cycle), and j is a suffix which denotes the continuous non-ejection period to which the target cycle is included, or the subsequent continuous ejection period of the continuous non-ejection period. In addition, Gmax is the last unit cycle of the unit period of controlling. Similarly, Rmax is the last continuous non-ejection period of the unit period of controlling, and Nmax is the last continuous ejection period of the unit period of controlling. In addition, according to the embodiment, the first of the unit period of controlling is set to the continuous non-ejection period R1, however, there may be a case where the first of the unit period of controlling is set to the continuous ejection period N1. Similarly, according to the embodiment, the last of the unit period of controlling is set to the continuous ejection period Nmax, however, there may be a case where the last of the unit period of controlling is set to the continuous non-ejection period Rmax.

When the continuous non-ejection period R(j) to which the target cycle is included is longer with respect to setting of the micro-vibration in the continuous non-ejection period to which the target cycle is included (that is, setting of the applied frequency of the micro-vibration pulse, and a micro-vibration voltage), when the continuous ejection period N(j) which is subsequent to the continuous non-ejection period R(j) is shorter, or when the length of the continuous ejection period N(j−1) which is immediately before the continuous non-ejection period R(j) is shorter, the opportunities of the ejection is small, and the ink tends to easily thicken. For this reason, it is preferable that the applied frequency of the micro-vibration pulse VP in the target cycle be higher, and the micro-vibration voltage Vhv of the micro-vibration pulse VP be set higher. On the other hand, when the continuous non-ejection period R(j) to which the target cycle is included is shorter, when the subsequent continuous ejection period N(j) is longer, and when the length of the immediately previous continuous ejection period N(j−1) is longer, the opportunities of the ejection is enough, and the ink do not tend to easily thicken. For this reason, it is preferable that the applied frequency of the micro-vibration pulse VP in the target cycle be lower, and the micro-vibration voltage Vhv of the micro-vibration pulse VP be set lower.

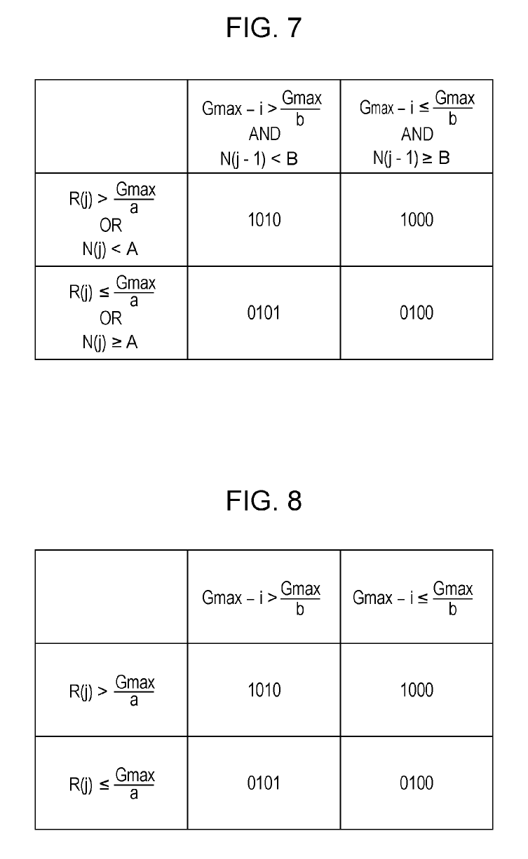

In order to set the optimal micro-vibration considering balances in the above described each condition, as shown in a table in FIG. 7, according to the embodiment, the pulse selection data corresponding to the second driving signal COM2 at the time of non-ejection is determined according to the ratio of the length of the continuous non-ejection period R(j) to which the target cycle is included (Gmax/a), the ratio with respect to the entire unit period (Gmax/b) of controlling of the length of the subsequent continuous ejection period N(j) and the length of a period until the Gmax after the target cycle (remaining period) (Gmax-i), and the length of the immediately previous continuous ejection period N(j−1). Here, a, b, A, and B are integers which can be arbitrarily determined.

More specifically, for example, when it is R(j)>Gmax/a, or N(j)<A, as the pulse data corresponding to the second driving signal COM2 with respect to the ejection data SI [00], [1010] is selected when Gmax-i>Gmax/b, and N(j−1)<B. In this case, the first micro-vibration pulse VP1 of the second driving signal COM2 is sequentially applied to the piezoelectric vibrator 17 in the periods T1a and T2a. In this manner, ink in the vicinity of the nozzle 27 is agitated by being continuously applied with a relatively large pressure vibration twice to an extent such that it will not eject ink in the nozzle 27 in the unit cycle T, accordingly, the ink is prevented from thickening. That is, in this case, the micro-vibration is performed by being set with a large applied frequency (two times), and a large micro-vibration voltage (Vdv1). In addition, in a case of R(j)>Gmax/a, or N(j)<A, when Gmax-i≦Gmax/b, and N(j−1)≧B, [1000] is selected as the pulse selection data corresponding to the second driving signal COM2 with respect to the ejection data SI [00]. In this case, the first micro-vibration pulse VP1 of the second driving signal COM2 is applied to the piezoelectric vibrator 17 in the period T1a. In this manner, the ink in the vicinity of the nozzle 27 is agitated by being applied with a relatively large pressure vibration only once to the extent such that it will not eject ink in the nozzle 27 in the unit cycle T. That is, in this case, the micro-vibration is performed by being set with a small applied frequency (one times), and a large micro-vibration voltage (Vdv1).

Similarly, in a case where R(j)≦Gmax/a, or N(j)≧A, when Gmax-i>Gmax/b, and N(j−1)<B, [0101] is selected as the pulse selection data corresponding to the second driving signal COM2 with respect to the ejection data SI [00]. In this case, the second micro-vibration pulse VP2 of the second driving signal COM2 is sequentially applied to the piezoelectric vibrator 17 in the periods T1b and T2b. In this manner, the ink in the vicinity of the nozzle 27 is agitated by being applied with a relatively small pressure vibration twice to the extent such that it will not eject ink in the nozzle 27 in the unit cycle T. That is, in this case, the micro-vibration is performed by being set with a large applied frequency (two times), and a small micro-vibration voltage (Vdv2). In addition, in a case where R(j)≦Gmax/a, or N(j)≧A, when Gmax-i≦Gmax/b, and N(j−1)≧B, [0100] is selected as the pulse selection data corresponding to the second driving signal COM2 with respect to the ejection data SI [00]. In this case, the second micro-vibration pulse VP2 of the second driving signal COM2 is sequentially applied to the piezoelectric vibrator 17 in the period T1b. In this manner, the ink in the vicinity of the nozzle 27 is agitated by being applied with a relatively small pressure vibration only once to the extent such that it will not eject ink in the nozzle 27 in the unit cycle T. That is, in this case, the micro-vibration is performed by being set with a small applied frequency (one times), and a small micro-vibration voltage (Vdv2).

Further, in addition to the above described setting of the micro-vibration, it is also possible to set such that the micro-vibration is not performed, or such that the applied frequency and the micro-vibration voltage are necessarily small in the last unit cycle of the immediately previous non-ejection period R(j) of the continuous ejection period N(j). Due to this, the subsequent ejection of ink is less affected by an influence of remaining vibration of the micro-vibration. In addition, according to the embodiment, the continuous ejection period is adopted as one of determining conditions, however, it is also possible to adopt the number of times of continuous ejection (for example, when the unit cycle in which the ejection is performed even once is continued, it is counted as the continuous ejection).

As described above, it is possible to perform more efficient micro-vibration of just the right degree, by changing the applied frequency of the micro-vibration pulse VP, and the micro-vibration voltage of the micro-vibration pulse VP with respect to the piezoelectric vibrator 17 in the non-ejection period, according to the length of the continuous non-ejection period, and the continuous ejection period before and after the non-ejection period which are determined from the ejection data SI. That is, under conditions prone to thickening, the thickening is prevented by performing larger and more micro-vibrations. It is possible to lower power consumption, suppress heating of a device, or obtain long life of the device by performing smaller and less micro-vibrations, under conditions difficult to thickening. In addition, since it is possible to perform a more efficient micro-vibration, particularly, it is preferable for a configuration in which highly viscous liquid such as UV ink (UV curable ink) or the like is ejected.

According to the embodiment, since the applied frequency, or the micro-vibration voltage of the micro-vibration pulse VP with respect to the piezoelectric vibrator 17 in the non-ejection period is changed according to a ratio to the entire unit period of controlling (Gmax/b) of the length of a period (remaining period) until the Gmax after the target cycle (Gmax-i), in addition to the length of the non-ejection period, and the ejection period before and after the non-ejection period, it is possible to perform a more efficient micro-vibration of just the right degree.

In addition, according to the embodiment, the second driving signal COM2 is configured by including a plurality of micro-vibration pulses of which driving voltages (micro-vibration voltages) are different from each other, it is possible to easily change the applied frequency of the micro-vibration pulse, or the micro-vibration voltage.

Meanwhile, the invention is not limited to the above described embodiment, and can be variously modified on the basis of the descriptions of claims.

For example, according to the embodiment, as setting conditions of the micro-vibration, a configuration has been exemplified in which three conditions of the length of the continuous non-ejection period, and the continuous ejection period before and after the non-ejection period which are determined from the ejection data SI, and the ratio to the entire unit period of controlling of the length of the period until the Gmax after the target period, however, the conditions are not limited to these, and it is possible to accomplish the operation effects of the invention, if the applied frequency, or the micro-vibration voltage of the micro-vibration pulse VP is set on the basis of at least any one of the conditions. For example, in the modification example in FIG. 8, the setting of the micro-vibration pulse is performed on the basis of two conditions of the continuous non-ejection period, and the ratio to the entire unit period of controlling of the length of the period until the Gmax after the target period.

In addition, it is also possible to adopt a configuration in which, for example, the applied frequency of the micro-vibration, or the micro-vibration voltage is determined by a function of the continuous non-ejection period or the continuous ejection period, without being limited only to the division of cases shown in FIGS. 7 and 8.

In addition, as an example of the micro-vibration pulse according to the embodiments of the invention, the first micro-vibration pulse VP1 and the second micro-vibration pulse VP2 shown in FIGS. 4 and 5 have been exemplified, however, the shape of the micro-vibration pulse is not limited to these, and it is possible to adopt a shape with an arbitrary waveform. In short, it may be any shapes which can drive the piezoelectric vibrator 17 to an extent such that it will not eject ink from the nozzle 27.

In addition, in each of the above described embodiments, as the pressure generation unit, a so-called longitudinal vibration type piezoelectric vibrator 17 has been exemplified, however, it is not limited to this. For example, it is also possible to adopt another pressure generation unit such as a so-called flexural vibration type piezoelectric vibrator, a heating element, an electrostatic actuator.

In addition, hitherto, the ink jet type recording head 2 as a type of the liquid ejecting head has been exemplified, however, it is also possible to apply the invention to another liquid ejecting head with a configuration in which the micro-vibration of liquid is performed by applying a micro-vibration pulse to the pressure generation unit. For example, it is also possible to apply the invention to a color material ejecting head which is used when manufacturing a color filter such as a liquid crystal display, an electrode material ejecting head which is used when forming electrodes such as an organic EL (Electro Luminescent) display, an FED (Field Emission Display), and a biological organic matter ejecting head which is used when manufacturing a biochip (a biochemical element).

What is claimed is:

1. A liquid ejecting apparatus comprising:
a liquid ejecting head which generates a pressure fluctuation in a pressure chamber by driving a pressure generation unit, by applying a driving signal, and ejects liquid from nozzles using the pressure fluctuation;
a driving signal generation unit which generates a driving signal including a micro-vibration pulse generating the pressure fluctuation in liquid in the pressure chamber to an extent such that it will not eject liquid from the nozzles in repeated cycles; and
a control unit which controls ejecting of the liquid by the liquid ejecting head on the basis of ejection data denoting the ejecting, or non-ejecting of the liquid in each repeated cycle, and controls the micro-vibration operations for each nozzle using the micro-vibration pulse,
wherein the control unit changes an applied frequency of the micro-vibration pulse, or a driving voltage of the micro-vibration pulse with respect to the pressure generation unit in a non-ejecting period, according to the length of the continuous non-ejecting period which is determined from the ejection data.

2. The liquid ejecting apparatus according to claim 1,
wherein the control unit changes the applied frequency of the micro-vibration pulse, or the driving voltage of the micro-vibration pulse with respect to the pressure generation unit in the non-ejecting period according to an ejecting period which is continuous before and after the non-ejecting period.

3. The liquid ejecting apparatus according to claim 1,
wherein the control unit changes the applied frequency of the micro-vibration pulse, or the driving voltage of the micro-vibration pulse with respect to the pressure generation unit in the non-ejecting period according to the proportion of the entire unit period of controlling from a target cycle in which the micro-vibration pulse is set, to the last unit cycle of the unit period of controlling.

4. The liquid ejecting apparatus according to claim 1,
wherein the driving signal has a configuration in which a plurality of micro-vibration pulses is included in one repeated cycle.

5. The liquid ejecting apparatus according to claim 4,
wherein the driving signal has a configuration in which the plurality of micro-vibration pulses with different driving voltages to each other is included in one repeated cycle.

6. A method of controlling a liquid ejecting apparatus which includes,
a liquid ejecting head which generates a pressure fluctuation in a pressure chamber by driving a pressure generation unit, by applying a driving signal, and ejects liquid from nozzles using the pressure fluctuation;
a driving signal generation unit which generates a driving signal including a micro-vibration pulse generating the pressure fluctuation in liquid in the pressure chamber to an extent such that it will not eject liquid from the nozzles in repeated cycles; and
a control unit which controls ejecting of the liquid by the liquid ejecting head on the basis of ejection data denoting the ejecting or non-ejecting of the liquid in each repeated cycle, and controls the micro-vibration operations for each nozzle using the micro-vibration pulse,
the method comprising:
changing an applied frequency of a micro-vibration pulse, or a driving voltage of a micro-vibration pulse with respect to a pressure generation unit in a non-ejecting period, according to the length of the continuous non-ejecting period which is determined from ejection data.
